(19) United States
(12) Patent Application Publication
(10) Pub. No.: US 2022/0277250 A1
(43) Pub. Date: Sep. 1, 2022

(54) SYSTEM AND METHOD FOR RIG EVALUATION

(71) Applicant: Saudi Arabian Oil Company, Dhahran (SA)

(72) Inventors: Olalekan Akinyemi Akiode, Dhahran (SA); William Contreras Otalvora, Dhahran (SA); Abdullah M. Al-Ali, Dammam (SA); Folorunsho Ajikobi, Dhahran (SA)

(21) Appl. No.: 17/188,387

(22) Filed: Mar. 1, 2021

(51) Int. Cl. G06Q 10/06; G06Q 10/10; G06Q 50/02; G05B 19/042; E21B 41/00

(52) U.S. Cl. CPC G06Q 10/06393; G06Q 10/10; G06Q 50/02; G05B 19/042; E21B 41/00; G05B 2219/32366

(57) ABSTRACT

A system and method control at least one rig by receiving key performance indicator (KPI) data of the at least one rig among a set of rigs, including at least one of flat time performance data, rig lost time performance data, health-safety-environment data, and local labor data. The KPI data is processed to determine at least one of a flat time score, a rig lost time score, a health-safety-environment score, and a local labor score as KPI scores. A rig efficiency index (REI) is determined from a weighting of the KPI scores. A control signal based on the REI is determined to control a first rig among the set of rigs.

### FIELD OF THE DISCLOSURE

The present disclosure relates generally to evaluating the performance of a rig in the petroleum industry, and, more particularly, to a system and method for evaluating a rig via automation.

### BACKGROUND OF THE DISCLOSURE

Methodologies are used to evaluate a rig in the petroleum industry, such as a well or other structures. Such methodologies often focus on measuring rig efficiency based solely on the mechanical performance of the rig, including the performance of components of the rig.

### SUMMARY OF THE DISCLOSURE

According to an embodiment consistent with the present disclosure, a system and method control the operation of at least one rig among a set of rigs by receiving key performance indicator (KPI) data of the at least one rig associated with the operations of the at least one rig in which a rig crew is the main responsibility. The KPI data can include flat time performance data, rig lost time performance data, health-safety-environment data, and local labor data. The KPI data is processed to determine a flat time score, a rig lost time score, a health-safety-environment score, and a local labor score as KPI scores. A rig efficiency index (REI) is determined from a weighting of the KPI scores. A control signal based on the REI is determined to control a first rig among the set of rigs.

In an embodiment, a system comprises an input device, a processor, a rig controller, and a connection. The input device is configured to receive key performance indicator (KPI) data of at least one rig, wherein the KPI data is selected from the group consisting of: flat time performance data, rig lost time performance data, and health-safety-environment data. The processor is configured by code executed therein to calculate a KPI score from the KPI data, and to calculate a rig efficiency index (REI) from the KPI score. The rig controller configured by code executed therein to generate and output a control signal based on the REI. The connection configured to convey the control signal to a first rig among the set of rigs to control the first rig by changing a state of operation of the first rig.

The processor calculates the REI from a weighting of the KPI score. The connection is a communication line connecting the rig controller to at least the first rig. The set of rigs includes a plurality of rigs, and the processor calculates the KPI score as an aggregated score of the plurality of rigs. The processor controls the first rig when the REI is less than a predetermined value. The changing of the state of operation of the first rig is selected from the group consisting of: re-bid the first rig, re-contract the first rig, release the first rig, and shut down the first rig. The system further comprises an output device configured to output the REI associated with the at least one rig. The set of rigs includes a plurality of rigs, and the output device outputs a ranked list of REIs associated with the plurality of rigs.

In another embodiment, a system used in conjunction with a rig connection comprises an input device, a processor, and a rig controller. The input device is configured to receive key performance indicator (KPI) data of at least one rig among a set of rigs, wherein the KPI data is selected from the group consisting of: flat time performance data, rig lost time performance data, and health-safety-environment data. The processor is configured by code executed therein to calculate a KPI score from the KPI data, and to calculate a rig efficiency index (REI) from the KPI score. The rig controller configured by code executed therein to generate and output, through the rig connection, a control signal based on the REI to control a first rig among the set of rigs by changing a state of operation of the first rig.

The processor calculates the REI from a weighting of the KPI scores. The set of rigs includes a plurality of rigs, and the processor calculates the KPI as an aggregated score of the plurality of rigs. The rig controller controls the first rig when the REI is less than a predetermined value. Changing of the state of operation of the first rig is selected from the group consisting of: re-bid the first rig, re-contract the first rig, release the first rig, and shut down the first rig. The system further comprises an output device configured to output the REI associated with the at least one rig. The set of rigs includes a plurality of rigs, and the output device outputs a ranked list of REIs associated with the plurality of rigs.

In a further embodiment, a method comprises receiving key performance indicator (KPI) data of at least one rig, wherein the KPI data is selected from the group consisting of: flat time performance data, rig lost time performance data, and health-safety-environment data. The method further comprises calculating a KPI score from the KPI data, calculating a rig efficiency index (REI) from the KPI scores, generating a control signal based on the REI, controlling, using the control signal, a first rig of the at least one rig, and changing a state of operation of the first rig. Calculating the REI includes weighting the KPI scores. The method further comprises determining whether the REI is less than a predetermined value, and controlling the first rig is performed when the REI is less than the predetermined value. The changing of the state of operation of the first rig is selected from the group consisting of: re-bid the first rig, re-contract the first rig, release the first rig, and shut down the first rig. The method further comprises outputting the REI associated with the at least one rig.

Any combinations of the various embodiments and implementations disclosed herein can be used in a further embodiment, consistent with the disclosure. These and other aspects and features can be appreciated from the following description of certain embodiments presented herein in accordance with the disclosure and the accompanying drawings and claims.

### BRIEF DESCRIPTION OF THE DRAWINGS

FIG. 1 is a schematic diagram of a control system, according to an embodiment.

FIG. 2 is a display screen configured to display icons for accessing and displaying KPI scores and REIs.

FIG. 3 is a display screen configured to display icons for accessing and displaying visualization data.

FIG. 4 is a flowchart of a method of operation of the control system of FIG. 1, according to the embodiment.

FIG. 5 is a flowchart configured to calculate KPI factors, according to the embodiment.

FIG. 6 is a flowchart configured to calculate KPI scores, according to the embodiment.

It is noted that the drawings are illustrative and are not necessarily to scale.

### DETAILED DESCRIPTION OF CERTAIN EMBODIMENTS OF THE DISCLOSURE

Example embodiments consistent with the teachings included in the present disclosure are directed to a system 10 and method 100 configured to control at least one rig by receiving key performance indicator (KPI) data of the at least one rig, including at least one of flat time performance data, rig lost time performance data, health-safety-environment data, and local labor data. The KPI data is processed to determine a flat time score, a rig lost time score, a health-safety-environment score, and a local labor score as KPI scores. A rig efficiency index (REI) is determined from a weighting of the KPI scores. A control signal based on the REI is determined to control a first rig among a set of rigs by changing of the state of operation of the first rig. Changing the state of operation can include at least one of re-bid the first rig, re-contract the first rig, release the first rig, and shut down the first rig.

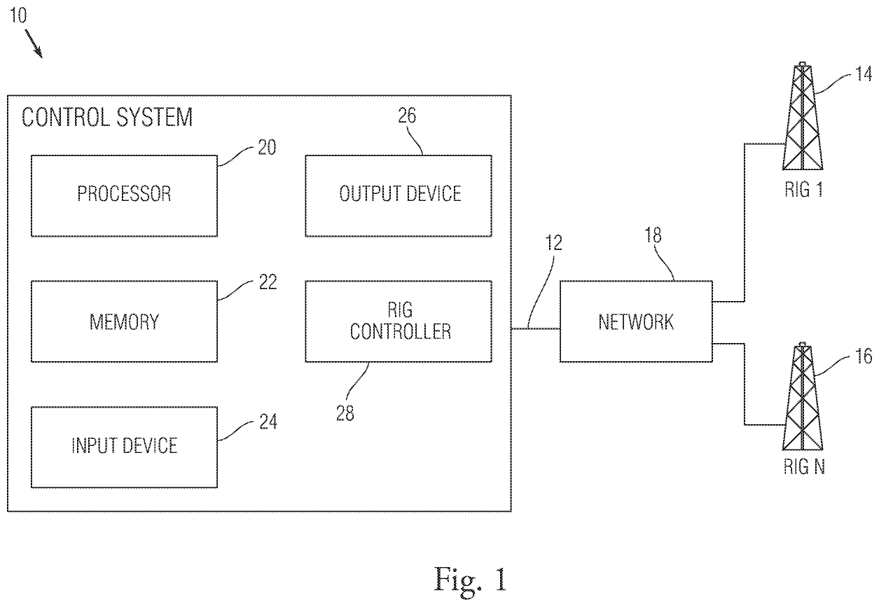

Referring to FIGS. 1-6, a control system 10 is connected by a connection 12 to at least one rig 14, 16, such as the rigs labeled Rig 1 to Rig N. As shown in FIG. 1, the connection 12 can be a communication line or interface between the control system 10 and at least one rig 14, 16. The connection can include a network 18. The network 18 can be the Internet. Alternatively, the network 18 can be a wide area network (WAN). In addition, the network 18 can be a local area network (LAN).

The control system 10 is configured to generate a control signal which is output through the connection 12 to one or more of the rigs 14, 16 in the set to control selected rigs such as a first rig 14 by changing of the state of operation of the first rig 14. Referring to FIG. 1, changing the state of operation can include at least one of re-bid the first rig 14, re-contract the first rig 14, release the first rig 14, and shut down the first rig 14.

The control system 10 includes a processor 20 having code executing therein. The control system 10 also includes a memory 22, an input device 24, an output device 26, and a rig controller 28. The processor 20 can receive KPI data from the input device 24. The input device 24 can be a communication interface to the connection 12. The communication interface can link to the rigs 14, 16 through the connection 12. As described above, the connection 12 can be a network 18 linking the rigs 14, 16 to the processor 20. For example, the rigs 14, 16 can include local processors having code executing therein configured to acquire drilling related KPI data. The acquired drilling related KPI data can be stored in local memory associated with each local processor, respectively. The local processor of each rig 14, 16 can transmit the drilling related KPI data through the network 18 to the input device 24. Alternatively, the processor 20 can receive KPI data from the memory 22. The memory 22 can include a data warehouse in which drilling related KPI data are stored.

Referring again to FIG. 1, the rig controller 28 can include code executing therein configured to generate the control signal based on the REI of one or more rigs 14, 16. If the REI for a given first rig 14 or for a set of rigs from among the plurality of rigs 14, 16 is less than a predetermined threshold value, then the rig controller 28 generates a control signal to change the state of operation of the first rig 14 or the set of rigs. For example, the predetermined threshold value can be 50%, so rigs with an REI under 50% have below average performance, such as shown in Table 1 below. Accordingly, such underperforming rigs are controlled to change their state of operation as described above.

TABLE 1

| PERFORMANCE LEVEL | REI RANGE |
|---|---|
| Superior Performance | 95-120 |
| High Performance | 85-95 |
| Consistent Performance | 75-85 |
| Average Performance | 50-75 |
| Below Average Performance | <50 |

The default predetermined threshold value can be 50%. Using the input device 24 having code executed therein configured to receive user inputs, such as inputs to a graphic user interface (GUI), a system administrator can manually select or change the predetermined threshold value to be any arbitrary value, such as 65%.

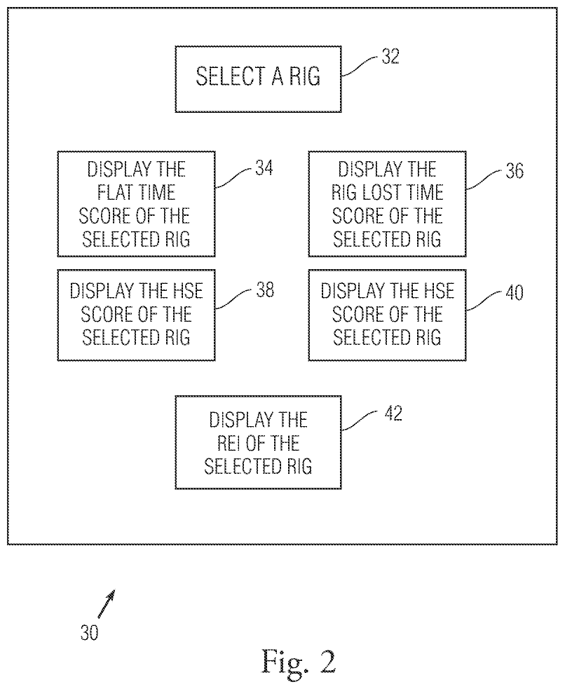

Referring to FIGS. 1-2, the output device 26 can provide a user interface 30 to allow the system administrator or any rig control operator to view the KPI scores and REI values of selected rigs. For example, the user interface 30, such as a GUI, has code executed therein configured to display actuatable icons as shown in FIG. 2. The icons can include an icon 32 configured to select a rig or a set of rigs. The icons can also include an icon 34 configured to display a flat time score of the selected rig. The icons can also include an icon 36 configured to display a rig lost time score of the selected rig. The icons can also include an icon 38 configured to display an HSE score of the selected rig. The icons can also include an icon 40 configured to display a local labor score of the selected rig. The icons can also include an icon 42 configured to display an REI of the selected rig.

Using the interface 30, the system administrator or rig control operator can input selections to view the KPI scores and REI scores in a ranked list, as shown in Table 2 below. The data in Table 2 can be gathered over a predetermined period, such as year-to-date or three years. The predetermined period can be set by default. Alternatively, the system administrator can use the input device 24 to set the predetermined period for performance level review and ranking. The interface 30 can also use visual effects to indicate performance levels consistent with Table 1 above. The visual effects can also highlight low performance areas, such as the zero entries under Lost Time Scores for Rigs O, P, and Q, or the entry of 40 under Flat Time Score for Rig Q. The visual effects can include color coding of performance levels. Alternatively, the visual effects can include blinking scores. The visual effects can also include blinking backgrounds of appropriate cells in Table 2.

TABLE 2

| Rank | Rig | Flat Time | Lost Time | HSE | Local Labor | REI |
|---|---|---|---|---|---|---|
| Number | Index | Score | Score | Score | Score | Score |
| 1 | A | 116 | 96 | 97 | 93 | 105 |
| 2 | B | 111 | 100 | 96 | 100 | 104 |
| 3 | C | 110 | 100 | 98 | 100 | 104 |
| 4 | D | 110 | 100 | 96 | 100 | 104 |
| 5 | E | 105 | 99 | 98 | 100 | 102 |
| 6 | F | 110 | 95 | 90 | 100 | 102 |
| 7 | G | 106 | 93 | 96 | 93 | 99 |
| 8 | H | 108 | 84 | 91 | 91 | 96 |
| 9 | I | 108 | 75 | 96 | 97 | 94 |
| 10 | J | 85 | 100 | 93 | 100 | 92 |
| 11 | K | 110 | 63 | 87 | 94 | 90 |
| 12 | L | 109 | 40 | 100 | 100 | 83 |
| 13 | M | 111 | 28 | 98 | 86 | 78 |
| 14 | N | 104 | 16 | 98 | 100 | 72 |
| 15 | O | 111 | 0 | 98 | 97 | 69 |
| 16 | P | 108 | 0 | 98 | 90 | 67 |
| 17 | Q | 40 | 0 | 86 | 100 | 38 |

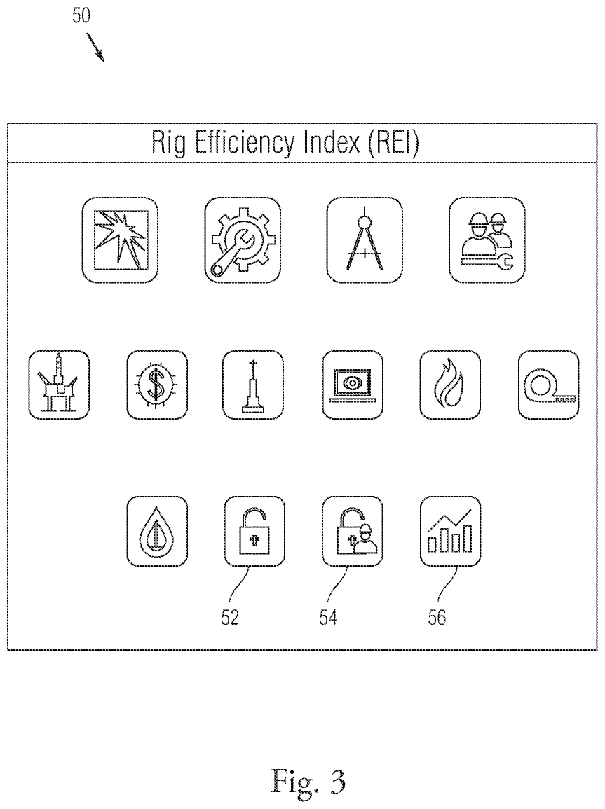

Referring to FIGS. 1 and 3, the output device 26 can also display an interface 50 of actuatable icons configured to display data corresponding to a label below each icon. Alternatively, the actuatable icons are configured to display data corresponding to the logo in each icon. For example, the icon 52 displays an open lock representing Open Period Analysis by Rig. In another example, the icon 54 displays an open lock with a technician image representing Open Period Analysis by Rig Provider. In a further example, the icon 56 displays a bar graph with a trend line representing Trend Analysis. The interface 50 can be a landing page of a website. The website can be an internal web-based document accessible through an intranet. Alternatively, the website can be a web-based document accessible to outsiders through an extranet. The implementation of the intranet and extranet can be secured using usernames and passwords. Using the interface 50 with actuatable icons, the displayed data facilitate visualization of the data. The interface 50 can use visualization tools commercially available through TIBCO SPOTFIRE. As described above, the data can be drilling related KPI data stored in a data warehouse. The data in Table 3 can be gathered over a predetermined period, such as year-to-date or three years.

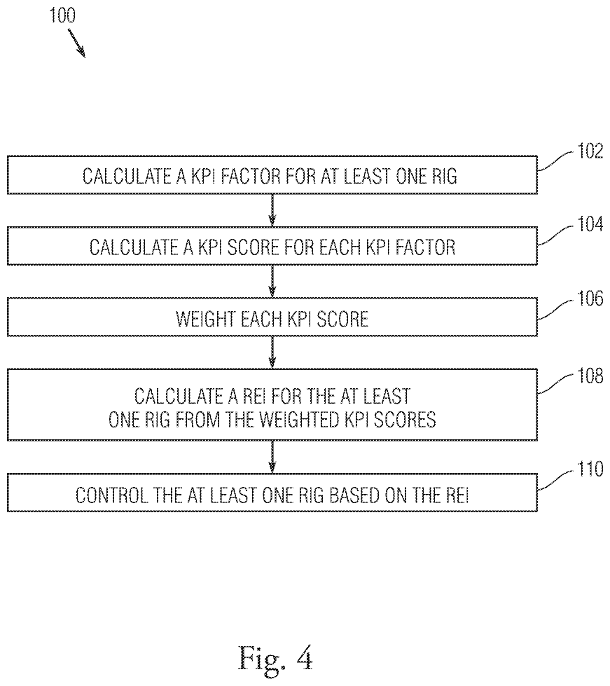

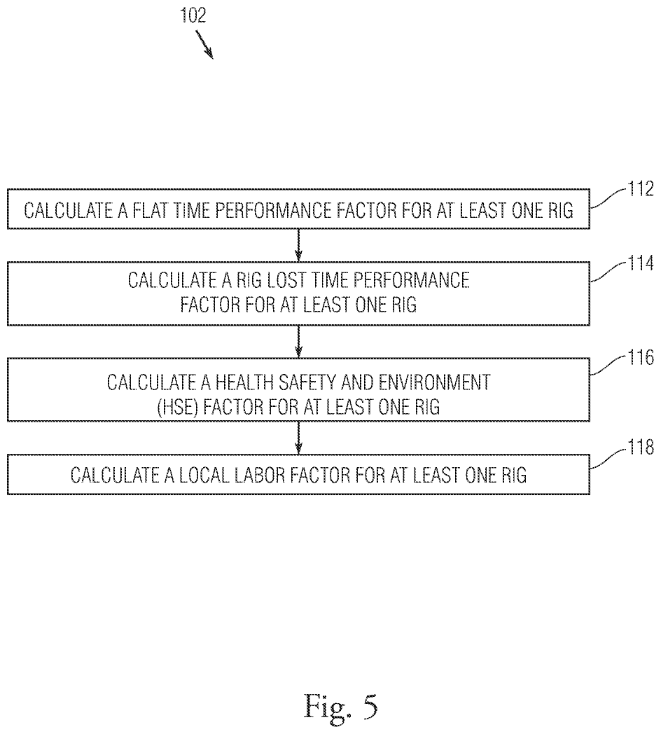

Referring to FIG. 4, a method 100 of operation of the system 10 includes the step of calculating a KPI factor for at least one rig 14, 16 in step 102. The KPI factor is determined from drilling related KPI data. The drilling related KPI data can include at least one of flat time performance data, rig lost time performance data, health-safety-environment data, and local labor data, and are calculated in steps 112, 114, 116, 118 of FIG. 5, as described below. The flat time performance data is related to flat time operations. Flat time operations are diverse during the drilling or workover of a single rig or well. Flat time is the time spent in activities that do not increase the depth of the well. However, there are some operations that are impacted directly by the performance of the rig crew, and other operations that do not. In measuring the rig performance, only activities affected by the rig crew performance are included. There are various flat time operations carried out on the rig. The flat time performance data measures flat time operations in the direct control of rig operators. Such flat time operations include cased hole tripping, casing running operations, upper completion running, and well head installation. For these flat time operations, predefined targets are set based on historical performance. These targets are digitally stored in a database in the memory, and compared with the actual time to perform the task.

In step 112 of FIG. 5, the method 102 determines the flat time performance (FTP) data for a single rig from the following equation:

$$F T P = ( \frac{Flat Time Target - A ctual Flat Time}{Flat Time Target} ) \times 100$$

However, for N rigs, with N>=1, the FTP for the aggregation of N rigs is determined from the following equation:

$$FTP = ( \frac{{\sum }_{1}^{N} Flat Time Target - {\sum }_{1}^{N} Actual Flat Time}{{\sum }_{1}^{N} Flat Time Target} ) \times 100$$

Rig lost time performance data measures the lost time, that is, any non-productive time attributed to a rig contractor operating a single rig. The acquisition of such rig lost time performance data is configured such that any lost time must be assigned to either a rig operating company, a rig provider, or a service company. In step 114 of FIG. 5, the method 102 determines the rig lost time performance (RLTP) data for a single rig from the following equation:

$$RLTP = \frac{Rig Lost Time}{Operating Time} \times 100$$

However, for N rigs, with N>=1, the RLTP for the aggregation of N rigs is determined from the following equation:

$$R L T P = ( \frac{{\sum }_{1}^{N} Rig Lost Time}{{\sum }_{1}^{N} Operating Time} ) \times 100$$

Health-safety-environment (HSE) data measures the degree of safe operations of a single rig based on the following KPIs in Table 3 below:

TABLE 3

| | Default |
|---|---|
| KPI | Weight Factor |
| High Potential Incident | 15 |
| Medium Potential Incident | 10 |
| Total Recordable Incident Rate | 30 |
| Percent of Rig HSE Inspection | 10 |
| (RHSEI) Compliance | |
| RHSEI Repetitive Findings | 5 |
| Percent of RHSEI Closure | 3 |
| Percent of Well Control Incidents | 15 |
| (WCI) Compliance | |
| Incident Investigation Corrective | 3 |
| Action Implementation Progress | |
| HSE GAP Analysis | 3 |
| Number of Near-Misses and Observations | 3 |
| Environmental Incidents | 3 |
| TOTAL | 100 |

In step 116 of FIG. 5, the method 102 determines the HSE performance data for a single rig by weighting each KPI in Table 3 and adding up the weight factors. For the High Potential Incident (HPI) factor, zero incidents receives a full weight of 15, 1 incident receives 70% of the full weight of 15, 2 incidents receives 40% of the full weight of 15, and 3 or more incidents receives 0% of the full weight of 15. The HPI factor is calculated based on a 24 month rolling period. The 24 month value is a default value, and can be set by a system administrator to be any arbitrary number of months.

For the Medium Potential Incident (MPI) factor, zero incidents receives a full weight of 10, 1 incident receives 75% of the full weight of 10, 2 incidents receives 60% of the full weight of 10, 3 incidents receives 45% of the full weight of 10, four incidents receives 30% of the full weight of 10, five incidents receives 15% of the full weight of 10, and 6 or more incidents receives 0% of the full weight of 10. The MPI factor is calculated based on a 24 month rolling period. The 24 month value is a default value, and can be set by a system administrator to be any arbitrary number of months.

For the Total Recordable Incident Rate (TRIR) factor, a highest TRIR value receives 0% of the full weight of 30%, while a lowest TRIR value receives the full weight of 30%. Otherwise, the TRIR factor for a rig is determined according to the Equation:

$$TRIR = ( \frac{Highest TRIR - Rig TRIR}{Highest TRIR} ) \times 100$$

Other factors such as Medical Treatment Cases (MTC), Loss Time Incidents (LTI), and Restricted Duty Incidents (RDI) are calculated and used to adjust the TRIR factor. For example, 1 LTI cause 25% of the TRIR weighted allocation to be deducted, 2 LTIs causes 50% of the TRIR weighted allocation to be deducted, 3 LTIs causes 75% of the TRIR weighted allocation to be deducted, and 4 LTIs causes 100% of the TRIR weighted allocation to be deducted.

The Percentage of RHSEI is determined to be the average percentage of RHSEI for the last three years multiplied by the weight factor of 10%. The three year value is a default value, and can be set by the system administrator to be any arbitrary number of years.

The RHSEI Repetitive Findings factor is calculated according to the following Equation:

$$RHSEI Repetitive Findings = \frac{Most Repetitive Findings - Rig Repetitive Findings}{Most Repetitive Findings}$$

and so for a rig with the Most Repetitive Findings, the weight factor is 0% of the full weight of 5, while a rig with the Least Repetitive Findings has the full weight of 5.

The Percentage of RHSEI Closure factor is the percentage of RHSEI closures multiplied by the weight factor of 3. The Incident Investigation Corrective Action Implementation Progress factor is a progress value, based on an incident investigation corrective action implementation plan for a rig, multiplied by the weight factor of 3. The Percentage of WCI Compliance factor is the percentage of WCI multiplied by the weight factor of 15. The HSE GAP Analysis factor is determined by GAP analysis value of Health, Safety, and Environment considerations of a rig, multiplied by a weight factor of 3.

The Number of Near-Misses and Observations factor is determined by the Equations:

$$Near Miss Factor = ( \frac{Highest \# of Near Misses - Number of Rig Near Misses}{Highest Number of Near Misses} ) \times 50$$

$$Observations factor = ( \frac{Number of Observations}{1000} ) \times 50$$

$$Total = ( Near Miss factor + Observations factor ) \times 3$$

in which a near-miss is an unplanned incident which under slightly different circumstances could have resulted in harm to people, damage to assets, financial loss and/or harm to the environment. In addition, an observation is a behavior-based observation which refers to a workplace safety program that focuses on identifying and eliminating at-risk behaviors or conditions as well as the identification of positive employee safety related behaviors. Note that any rig with zero observations receives 0% of the weighted allocation of 3. The maximum observations for each rig is 1,000 over a 12 month period. Any rig with more than 1,000 observations counts as 1,000 observations. The 1,000 observations value is a default value, and can be set by the system administrator to be any arbitrary number of observations.

The Environmental Incidents (EI) factor measures the number of incidents of the rig affecting the environment, such as oil spills. If there are zero incidents, the EI factor receives the full weighted value of 3, one incident causes the EI factor to receive 75% of the full weighted value of 3, two incidents causes the EI factor to receive 50% of the full weighted value of 3, three incidents causes the EI factor to receive 25% of the full weighted value of 3, and four incidents causes the EI factor to receive 0% of the full weighted value of 3.

The final HSE performance factor for a single rig is then determined to be the sum total of the weighted factors for a single rig in Table 3.

Local labor data addresses a drive to have rig contractors employ local labor force on their rig to a certain degree. In step 118 of FIG. 5, the method 102 determines the local labor performance data as a Local Labor performance factor for a single rig. The Local Labor performance factor for a single rig is determined according to the following Equation:

$$Local Labor factor = ( \frac{Actual local labor working for a rig}{Target local labor for the rig} ) \times 100$$

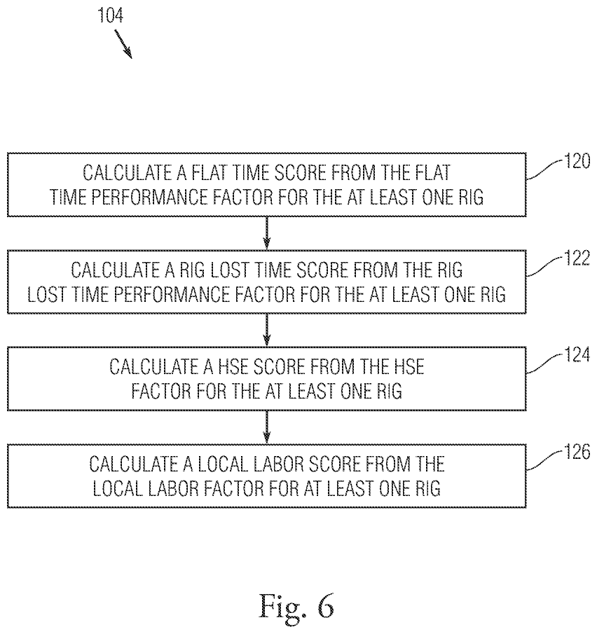

Referring back to FIG. 4, the method 100 then calculates a KPI score for each KPI factor in step 104, and are calculated in steps 120, 112, 124, 126 of FIG. 6, as described below. In step 120, the method 104 calculates a flat time score from the flat time performance factor described above for the at least one rig. The flat time performance factor reflects how the actual time of the operation of the at least one rig differs from a target time. If the flat time performance factor is zero, the actual time and the target time are identical, so activity of the at least one rig meets the expectations of operation of the rigs, and the flat time score would be 100. If the flat time performance factor is positive, the operation of the at least one rig was performed in less time than expected, and so the flat time score would vary between 100 and 120. However, if the flat time performance factor is negative, the operation of the at least one rig has not met expectations, and so the flat time score is less than 100, and varies in the range of zero to 100. The flat time score (FTS) is determined from the following equations:

$$If FTP > 0 , then FTS = 100 + ( \frac{F T P * 20}{Best FTP} )$$

$$If FTP = 0 , then FTS = 10 \; 0$$

However, if the FTP<0, then the FTS score for a single rig is determined from Table 4 below:

TABLE 4

| Flat Time Performance | Flat Time Score |
|---|---|
| (FTP) Range | (FTS) Range |
| −5.0 <= FTP <= 0 | 90 <= FTS <= 100 |
| −15.0 <= FTP <= −5.01 | 60 <= FTS <= 89.9 |
| −30.0 <= FTP <= −15.01 | 10 <= FTS <= 59.9 |
| −40.00 <= FTP <= −30.01 | 0 <= FTS <= 9.9 |
| FTP <= −40 | FTS = 0 |

In step 122, the method 104 calculates a rig lost time score (RLTS) from the rig lost time performance (RLTP) factor described above for the at least one rig. The rig lost time performance factor reflects the percentage of lost time associated with a rig company compared to the total operating time of the at least one rig. To calculate and normalize the rig lost time score, a maximum tolerance value of the RLTS is set to 3.5%. Any rig that has a RLTP factor of 3.5% or higher receives a RLTS of 0. If the at least one rig has an RLPT factor of zero, then at least one rig receives a RLTS of 100. Any RLTP factor between zero and 3.5% receives a RLPS between zero and 100, according to the following Table 5:

TABLE 5

| Rig Lost Time Performance | Rig Lost Time Score |
|---|---|
| (RLTP) Range | (RLTS) Range |
| 0 <= RLTP <= 1.00 | 100 >= RLTS >= 80 |
| 1.01 <= RLTP <= 2.00 | 79.9 >= RLTS >= 60 |
| 2.01 <= RLTP <= 2.50 | 59.9 >= RLTS >= 40 |
| 2.51 <= RLTP <= 3.00 | 39.9 >= RLTS >= 20 |
| 3.01 <= RLTP <= 3.50 | 9.9 >= RLTS >= 0 |
| RLTP >= 3.5 | RLTS = 0 |

In step 124, the method 104 calculates a HSE score (HSES) equal to the HSE factor described above for a single rig. For N rigs, with N>=1, the HSES for the aggregation of N rigs is determined from the following equation:

$$HSES = ( \frac{{\sum }_{1}^{N} HSES for each rig}{N \times ( The Number of Months )} )$$

The HSE score does not require normalization. In an alternative embodiment, the HSE score has an overriding effect on the control of operations of the rig. For rigs with one fatality with the rig contractor being the responsible party, once the initial REI is determined, the final REI is set to 60% of the initial REI over the next 12 months. Furthermore, if a rig has two fatalities, the final REI is set to zero.

In step 126, the method 104 calculates a local labor score (LLS) from the local labor factor described above for the at least one rig. If the local labor factor is greater than or equal to 100, then the LLS is equal to 100 for a single rig. Otherwise, the LLS is equal to the local labor factor for a single rig. However, for N rigs, with N>=1, the LLS for the aggregation of N rigs is determined from the following equation:

$$L L S = ( \frac{{\sum }_{1}^{N} LLS for each rig}{N \times ( The Number of Months )} )$$

Referring back to FIG. 4, the method 100 then weights each KPI score in step 106. The flat time score (FTS) has an associated weight W1, the rig lost time score (RLTS) has an associated weight W2, the health-safety-environment score (HSES) has an associated weight W3, and the local labor score (LLS) has an associated weight W4. Using the input device 24, a system administrator can set the weights W1, W2, W3, and W4. For example, if control of operations of a rig are to be determined regardless of local labor considerations, the weight W4 can be set to zero.

Referring back to FIG. 4, the method 100 then calculates a REI for the at least one rig 14, 16 in step 108, according to the following equation:

REI=W1×FTS+W2×RLTS+W3×HSES+W4×LLS

Referring back to FIG. 4, the method 100 then controls the at least one rig based on the REI in step 110 by changing a state of operation of the at least one rig 14, 16, as described above. The system 10 can focus on the performance of each rig 14, 16 individually or in aggregation. In addition, using the system 10 and method 100, other aspects or dimensions of performance in which the rigs are operating can be analyzed. Analysis can focus on rig companies, rig types, rig contract types, well types, operating departments, rig locations, etc.

In one example, for a parent rig company, the company can supply five rigs for a client. The performance of the rigs can be calculated independently, and the overall performance of the company is also calculated. Company performance can also be ranked in a format similar to Table 2 above. In another example, with regard to an operations department of a company, different rigs can be drilling for the same department. While the performance of the rigs can be calculated independently, the overall performance of the operations department can also be calculated. Operations department performance can then be ranked in a format similar to Table 2 above.

In a further example, overall company performance can be analyzed and evaluated. The performance of all rigs drilling for the company can be combined and delivered as a single number as the REI. A trend of the numbers can indicate the overall performance or health of the company. In another example, rigs can be analyzed in a different manner depending on whether the rigs are located geographically onshore or offshore. The performance of offshore rigs and of onshore rigs can be compared using a ranking in a format similar to Table 2 above.

Portions of the methods described herein can be performed by software or firmware in machine readable form on a tangible (e.g., non-transitory) storage medium. For example, the software or firmware can be in the form of a computer program including computer program code adapted to cause the control system to perform various actions described herein when the program is run on a computer or suitable hardware device, and where the computer program can be embodied on a computer readable medium. Examples of tangible storage media include computer storage devices having computer-readable media such as disks, thumb drives, flash memory, and the like, and do not include propagated signals. Propagated signals can be present in a tangible storage media. The software can be suitable for execution on a parallel processor or a serial processor such that various actions described herein can be carried out in any suitable order, or simultaneously.

It is to be further understood that like or similar numerals in the drawings represent like or similar elements through the several figures, and that not all components or steps described and illustrated with reference to the figures are required for all embodiments or arrangements.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “contains”, “containing”, “includes”, “including,” “comprises”, and/or “comprising,” and variations thereof, when used in this specification, specify the presence of stated features, integers, steps, operations, elements, and/or components, but do not preclude the presence or addition of one or more other features, integers, steps, operations, elements, components, and/or groups thereof.

Terms of orientation are used herein merely for purposes of convention and referencing and are not to be construed as limiting. However, it is recognized these terms could be used with reference to an operator or user. Accordingly, no limitations are implied or to be inferred. In addition, the use of ordinal numbers (e.g., first, second, third) is for distinction and not counting. For example, the use of “third” does not imply there is a corresponding “first” or “second.” Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

While the disclosure has described several exemplary embodiments, it will be understood by those skilled in the art that various changes can be made, and equivalents can be substituted for elements thereof, without departing from the spirit and scope of the invention. In addition, many modifications will be appreciated by those skilled in the art to adapt a particular instrument, situation, or material to embodiments of the disclosure without departing from the essential scope thereof. Therefore, it is intended that the invention not be limited to the particular embodiments disclosed, or to the best mode contemplated for carrying out this invention, but that the invention will include all embodiments falling within the scope of the appended claims.

The subject matter described above is provided by way of illustration only and should not be construed as limiting. Various modifications and changes can be made to the subject matter described herein without following the example embodiments and applications illustrated and described, and without departing from the true spirit and scope of the invention encompassed by the present disclosure, which is defined by the set of recitations in the following claims and by structures and functions or steps which are equivalent to these recitations.

What is claimed is:

1. A system, comprising:
an input device configured to receive key performance indicator (KPI) data of at least one rig among a set of rigs, wherein the KPI data is selected from the group consisting of: flat time performance data, rig lost time performance data, and health-safety-environment data;
a processor configured by code executing therein to calculate a KPI score from the KPI data, and to calculate a rig efficiency index (REI) from the KPI score;
a rig controller configured by code executing therein to generate and output a control signal based on the REI; and
a connection configured to convey the control signal to a first rig among the set of rigs to control the first rig by changing a state of operation of the first rig.

2. The system of claim 1, wherein the processor calculates the REI from a weighting of the KPI scores.

3. The system of claim 1, wherein the connection is a communication line connecting the rig controller to at least the first rig.

4. The system of claim 1, wherein the set of rigs includes a plurality of rigs, and wherein the processor calculates the KPI score as an aggregated score of the plurality of rigs.

5. The system of claim 1, wherein the processor controls the first rig when the REI is less than a predetermined value.

6. The system of claim 1, wherein the changing of the state of operation of the first rig is selected from the group consisting of: re-bid the first rig, re-contract the first rig, release the first rig, and shut down the first rig.

7. The system of claim 1, further comprising:
an output device configured to output the REI associated with the at least one rig.

8. The system of claim 7, wherein the set of rigs includes a plurality of rigs, and wherein the output device outputs a ranked list of REIs associated with the plurality of rigs.

9. A system used in conjunction with a rig connection, comprising:
an input device configured to receive key performance indicator (KPI) data of at least one rig among a set of rigs, wherein the KPI data is selected from the group consisting of: flat time performance data, rig lost time performance data, and health-safety-environment data;
a processor configured by code executed therein to calculate a KPI score from the KPI data, and to calculate a rig efficiency index (REI) from the KPI score; and
a rig controller configured by code executed therein to generate and output, through the rig connection, a control signal based on the REI to control a first rig among the set of rigs by changing a state of operation of the first rig.

10. The system of claim 9, wherein the processor calculates the REI from a weighting of the KPI scores.

11. The system of claim 9, wherein the set of rigs includes a plurality of rigs, and wherein the processor calculates the KPI as an aggregated score of the plurality of rigs.

12. The system of claim 9, wherein the rig controller controls the first rig when the REI is less than a predetermined value.

13. The system of claim 9, wherein the changing of the state of operation of the first rig is selected from the group consisting of: re-bid the first rig, re-contract the first rig, release the first rig, and shut down the first rig.

14. The system of claim 9, further comprising:
an output device configured to output the REI associated with the at least one rig.

15. The system of claim 14, wherein the set of rigs includes a plurality of rigs, and
wherein the output device outputs a ranked list of REIs associated with the plurality of rigs.

16. A method, comprising:
receiving key performance indicator (KPI) data of at least one rig among a set of rigs, wherein the KPI data is selected from the group consisting of: flat time performance data, rig lost time performance data, and health-safety-environment data;
calculating a KPI score from the KPI data;
calculating a rig efficiency index (REI) from the KPI scores;
generating a control signal based on the REI;
controlling, using the control signal, a first rig among the set of rigs; and
changing a state of operation of the first rig.

17. The method of claim 16, wherein calculating the REI includes:
weighting the KPI scores.

18. The method of claim 16, further comprises:
determining whether the REI is less than a predetermined value; and
wherein controlling the first rig is performed when the REI is less than the predetermined value.

19. The method of claim 16, wherein the changing of the state of operation of the first rig is selected from the group consisting of: re-bid the first rig, re-contract the first rig, release the first rig, and shut down the first rig.

20. The method of claim 16, further comprising:
outputting the REI associated with the at least one rig.
